(19) United States
(12) Patent Application Publication
(10) Pub. No.: US 2026/0065217 A1
(43) Pub. Date: Mar. 5, 2026

(54) Identifying Cargo

(71) Applicant: Saudi Arabian Oil Company, Dhahran (SA)

(72) Inventors: Abdulaziz J. Alahmadi, Al Khobar (SA); Moaathe O. Kidwai, Dhahran (SA); Ahmed S. Al-Zahrani, Dhahran (SA); Ahmed A. Al-Zahrani, Dhahran (SA)

(21) Appl. No.: 18/822,926

(22) Filed: Sep. 3, 2024

(51) Int. Cl. G06Q 10/087; G06K 7/14; G06T 7/70

(52) U.S. Cl. CPC G06Q 10/087; G06K 7/1417; G06T 7/70; G06T 2207/20081; G06T 2207/30242; G06T 2207/30252

(57) ABSTRACT

Systems and methods for identifying cargo on a truck include capturing a digital image of cargo on a truck using a digital camera and determining a count of items in the cargo by digitally processing the image of the cargo using a machine learning model trained to identify the items in the image. A unique identifier can be identified in the image corresponding to a type of the items in the cargo, and the type of the items in the cargo can be determined based on the unique identifier. The count of items and the type of items is compared to an expected count and an expected type.

### TECHNICAL FIELD

This disclosure generally relates to identifying cargo, for example, cargo loaded on a trailer.

### BACKGROUND

Cargo (e.g., pipes for use in oil and gas facilities) can be stored in storage facilities for use at a later time. The inventory of a storage facility can fluctuate based on the intake and outtake of cargo from the storage facility. For example, a truck carrying cargo can enter the storage facility increasing the inventory. A truck carrying cargo leaving the storage facility decreases the inventory. An inventory management system can record the intake and outtake of cargo from the storage facility.

This disclosure describes an approach for identifying cargo automatically. Identifying cargo on trucks entering or leaving a storage facility is important to maintain accurate records of the inventory in the storage facility. Additionally, trucks entering the storage facility can be directed to specified locations within the storage facility based on the cargo on the truck. Automatic identification of cargo can be more accurate and faster than manual identification. Improved accuracy and reliability can improve inventory records.

A data processing system can capture an image of a truck entering or exiting the storage facility (e.g., using a digital camera). The data processing system can process the image using a machine learning model to determine a count of cargo on the truck. Additionally, the data processing system can detect unique identifiers on the cargo to determine types of cargo on the truck. The data processing system can compare the determined count and types of cargo to an expected count and types of cargo (e.g., based on a shipping manifest). The data processing system can cause a variety of actions to be performed based on the comparison. For example, the data processing system can open a gate to allow the truck to enter or leave the facility. Additionally, or alternatively, the data processing system can render for display, or print using a printer, an indication of the match or mismatch of the determined count and types of cargo with the expected count and types of cargo. The data processing system can update an inventory management system based on the determined count and types of cargo.

In example implementations of this approach, systems and methods for identifying truck cargo can include capturing a digital image of cargo on a truck using a digital camera. A data processing system determines a count of items in the cargo by digitally processing the image of the cargo using a machine learning model trained to identify the items in the image. The data processing system identifies a unique identifier in the image corresponding to a type of the items in the cargo. The data processing system determines the type of the items in the cargo based on the unique identifier. the data processing system compares the count of items and the type of items to an expected count and an expected type. The data processing system opens a gate to allow the truck to pass the gate.

In some instances, in response to determining that the count and the type match the expected count and the expected type, the data processing system performs an action. For example, the data processing system can print or render for display a goods received slip. Alternatively, or additionally, the data processing system can update an inventory of items in an inventory management system.

Implementations of the systems and methods of this disclosure can provide various technical benefits. For example, this approach can decrease errors in cargo identification compared with manual methods. This approach uses less hardware than other systems such as weighing stations or scales. The hardware used by this approach is also easier to install than other systems thereby enabling simple installation and retrofitting of current entry and exit gates. This approach can improve truck intake procedures for entry into a storage facility by decreasing the time between truck arrival and load receiving in the storage facility by automatically identifying the count and types of cargo on the truck. Based on the identification, the truck can be directed to the appropriate location within the storage facility. This approach can automatically update inventory management systems with inventory entering or leaving a facility based on cargo identified on the truck entering or leaving the facility. Errors between shipping manifests and actual cargo onboard a truck can be detected by this approach, and the errors can be corrected before the truck leaves the storage facility thereby improving the accuracy of the shipment. This approach can include a sensor to trigger a camera to capture an image of the cargo at a specific location of the truck providing repeatability in the image and reducing capture of erroneous images. The sensor enables the camera to be actively powered only when a truck with cargo is present thereby reducing power consumption of the system.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic of a system for identifying truck cargo.

FIG. 2 is an overhead schematic of a truck carrying pipes as cargo.

FIG. 3 is a flow chart for a method of identifying cargo.

FIG. 4 is a flow chart of another method of identifying cargo.

FIG. 5 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This disclosure describes an approach for identifying cargo automatically. Identifying cargo on trucks entering or leaving a storage facility is important to maintain accurate records of the inventory in the storage facility. Additionally, trucks entering the storage facility can be directed to specified locations within the storage facility based on the cargo on the truck. Automatic identification of cargo can be more accurate and faster than manual identification. Improved accuracy and reliability can improve inventory records.

A data processing system can capture an image of a truck entering or exiting the storage facility (e.g., using a digital camera). The data processing system can process the image using a machine learning model to determine a count of cargo on the truck. Additionally, the data processing system can detect unique identifiers on the cargo to determine types of cargo on the truck. The data processing system can compare the determined count and types of cargo to an expected count and types of cargo (e.g., based on a shipping manifest).

The data processing system can cause a variety of actions to be performed based on the comparison. For example, the data processing system can open a gate to allow the truck to enter or leave the facility. Additionally, or alternatively, the data processing system can render for display, or print using a printer, an indication of the match or mismatch of the determined count and types of cargo with the expected count and types of cargo. The data processing system can update an inventory management system based on the determined count and types of cargo.

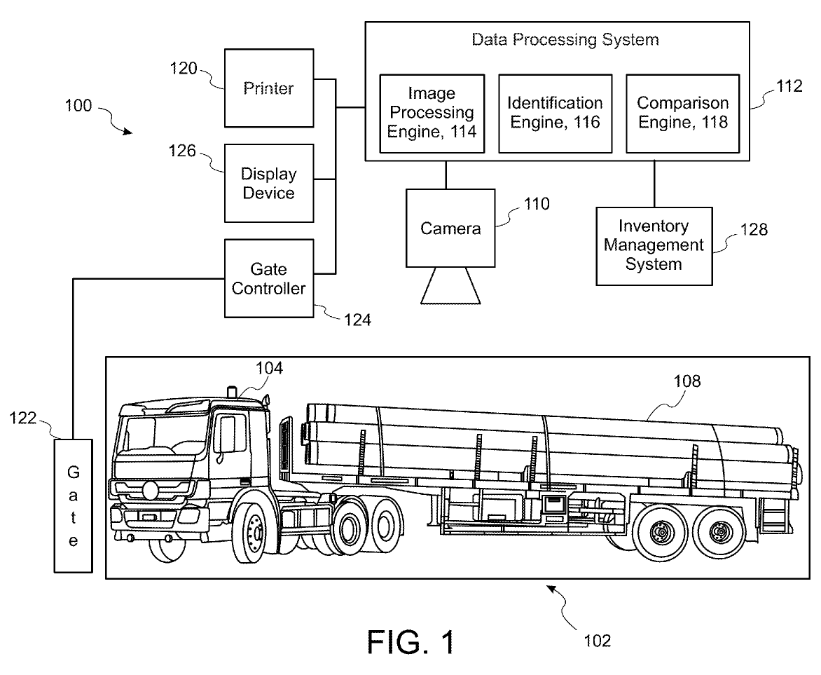

FIG. 1 is a schematic for an example system 100 for identifying cargo on a truck 102. The system 100 can be installed, for example, at the entrance or exit of the storage facility to identify the cargo on trucks entering or leaving the storage facility. The illustrated embodiment shows a truck 102 that includes a cab 104 pulling a flatbed trailer 106 loaded with pipes 108. The system 100 can be used to identify other types of cargo also, for example, the system 100 can identify generators, hydrocarbon production equipment, etc.

The system 100 includes a camera 110 configured to capture an image of the pipes 108. The camera 110 can be, for example, a digital camera that captures a digital image of the pipes 108. The camera 110 can be mounted to view the pipes 108 straight down from an overhead position. Alternatively, the camera can be mounted to view the pipes 108 at a slight angle to the vertical to see pipes that would be occluded from a directly vertical viewing position. The camera 110 is communicatively coupled to a data processing system 112. For example, the camera 110 can be coupled to the data processing system 112 through a wired connection (e.g., ethernet, coaxial, universal serial bus (USB), etc.) or a wireless connection (e.g., wireless local area network (WLAN), cellular, short range radio communications, etc.). The camera 110 can capture one image of the pipes 108 or multiple images. The images can be stored in a database to be accessed at a later time (e.g., during an audit or to confirm an incorrect count). In some implementations, the system 100 includes multiple cameras that view the pipes from different angles to enable the system 100 to see around or through partial occlusions.

In some implementations, the system 100 includes a sensor that detects when a truck is positioned at the gate. The sensor can generate a signal to trigger the camera 110 to capture the image of the pipes 108 when the truck 102 is at the gate 122. Using a sensor to trigger the camera 110 can improve the repeatability of the location of the truck 102 in the images. Further, the camera 110 can be actively powered when the camera 110 receives the signal to capture the image and inactive at other times thereby reducing energy consumption by the system 100.

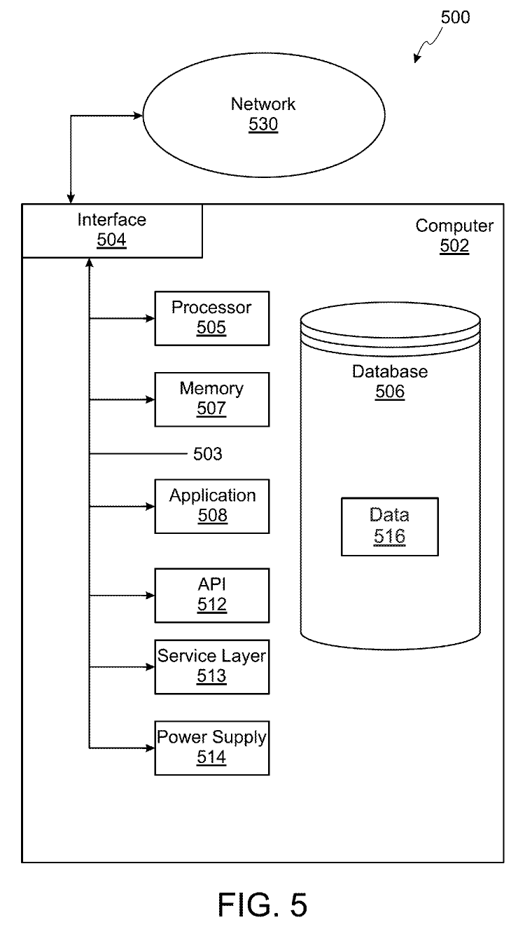

The data processing system 112 is a computer or control system (e.g., the computer system of FIG. 5). The data processing system 112 includes at least one processor and computer readable media storing instructions to cause performance of operations when executed by the at least one processor. The data processing system 112 includes multiple engines to receive and process data and generate commands for execution by peripheral devices. The engines include an image processing engine 114, an identification engine 116, and a comparison engine 118. The peripheral devices include a printer 120, a gate controller 124 operable to open and close the gate 122, and a display device 126. Some systems include other or additional peripheral devices and systems. The data processing system 112 can be communicatively coupled to the peripheral devices through wired connections, wireless connections, or a combination of wired and wireless connections.

The data processing system 112 receives images from the camera 110. The image processing engine 114 processes the images to determine the count and type of pipes 108 on the truck 102. For example, the image processing engine 114 processes the images using a trained machine learning model to determine the count or type of the pipes 108. The machine learning model can be, for example, a convolutional neural network (CNN) that identifies pipes and/or unique identifiers in the image. The count of pipes 108 can be determined based on the number of pipes or unique identifiers identified by the machine learning model.

In some implementations, the data processing system 112 receives a video stream from the camera 110 and the images correspond to frames from the video. The image processing engine 114 can process the frames from the video to determine the count and type of pipes on the truck.

The identification engine 116 recognizes unique identifiers on the pipes 108 from the images received from the camera 110 and decodes the unique identifiers. The unique identifiers include information about the pipes (e.g., wall thickness, diameter, length, material, serial number, coatings, etc.). The unique identifiers can be, for example, a one-dimensional code such as a barcode or a two dimensional code such as a quick response (QR) code. Other types of identifiers are also possible (e.g., a text label). The unique identifiers can be located in a standard location on the pipes to facilitate identification and decoding of the unique identifier. For example, the unique identifier can be attached to the pipes 108 near the back end of the pipes 108 on the trailer 106. The unique identifier can be positioned to face in the direction of the camera (e.g., facing up to be viewed by an overhead camera). In some implementations, multiple copies of the unique identifier are attached to the pipe to facilitate identification of the pipes independently of the pipe orientation. Unique identifiers attached to pipes below the topmost layer of pipes can be captured by a camera viewing the pipes at an angle from the vertical.

In implementations where the unique identifiers include QR codes, the QR codes can use a high correction level to increase the accuracy of determining the serial number of the pipe. For example, automatically adding one to the serial number of the pipe for sequentially labeled pipes results in only small changes in the QR code. The small changes can lead to decreased accuracy. Using a high correction level in the QR code increases the density of the QR code and allows up to 30% of the QR code to be changed or altered without affecting the readability of the QR code. The more significant differences in the QR codes for sequential serial numbers caused by using the high correction level results in more accurate decoding of the QR codes. Using a high correction level in the QR code also reduces effects of damage to the QR codes caused during transit of the truck 102 (e.g., transit between storage facilities). For example, the truck 102 and pipes 108 can be exposed to severe weather (e.g., sandstorms, extreme heat, winds, rain) that can damage the QR code. Using the high correction level, the QR code can be read with up to 30% of the QR code damaged.

In some implementations, the identification engine 116 uses object or pattern recognition to identify the type of pipe. For example, the identification engine 116 can identify the type of pipe based on the size and shape of the pipe. In some implementations, a machine learning model is trained using labeled images of pipes to identify the type of pipe in the cargo.

The data processing system 112 can access expected counts and types of pipes by accessing information about an identified pipe from the inventory management system 128. For example, the data processing system 112 can identify a pipe and access the entry in the inventory management system 128 that indicates that the pipe is in transit to or from a storage facility. The entry in the inventory management system 128 can include information about the shipment that the pipe is included in, and the data processing system 112 can access the information about the shipment such as the number and types of pipes in the shipment and the associated identifiers of the pipes.

In some implementations, the identification engine 116 can also identify a truck in the image. For example, the truck can be identified based on a license plate or other identifier. Based on the identified truck, the data processing system 112 can access information about cargo on the truck (e.g., a shipment manifest) from an inventory management system 128.

In the system 100, the comparison engine 118 compares data received from the image processing engine 114 and the identification engine 116. For example, the comparison engine compares the count and type of pipe determined from the image processing engine 114 and the identification engine 116 with the expected count and type of pipe (e.g., from a shipment manifest or from the inventory management system 128). The comparison engine 118 determines if the determined count and type of pipe and the expected count and type of pipe match. In some implementations, the comparison engine 118 compares each uniquely identified pipe with expected pipes in the shipment to verify that the specific pipes in the shipment match the specifically expected pipes in the shipment.

The comparison engine 118 generates instructions for actions to be performed based on the match or mismatch of data. For example, when the comparison engine 118 determines that the data matches, the comparison engine 118 can cause the printer 120 to print a goods receipt and open the gate 122 via the gate controller 124. Alternatively, or additionally, the comparison engine 118 can cause an indication of the match or mismatch to be rendered for display on the display device 126. Alternatively, or additionally, the comparison engine 118 can cause the printer 120 to print the image captured by the camera 110 or the display device 126 to display the image. The image can be used to verify the identified cargo and to help resolve discrepancies between the identified cargo and the expected cargo.

The data processing system 112 can update the inventory management system 128 based on the determined pipe count and types. Additionally, the data processing system 112 can store data in the inventory management system 128 indicating discrepancies (e.g., mismatched data) between the determined count and type of pipes and the expected count and type of pipes. Updating the inventory management system 128 can include, for example, adding pipe information and counts to the inventory records of the storage facility (e.g., adding database entries) based on the determined count and type of pipes when a truck is entering the storage facility. Alternatively, updating the inventory management system 128 can include removing pipes from the inventory records of the storage facility (e.g., removing database entries) based on the determined count and types of pipes.

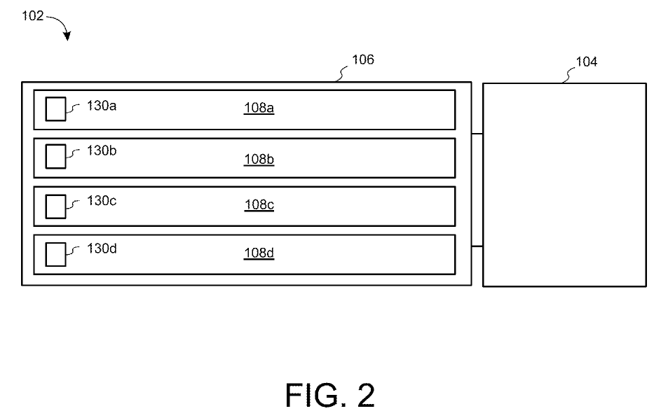

FIG. 2 is a schematic of an overhead view of the truck 102. When the camera 110 is positioned to capture an overhead view of the truck 102, individual pipes 108a-d can be identified and counted. Additionally, each pipe 108a-d has a unique identifier 130a-d (e.g., QR code or barcode) attached to the pipe 108a-d. Each unique identifier 130a-d includes specific information about the pipe to which it is attached. In some implementations, the pipes 108a-d are the same size and type of pipe. In some implementations, the pipes 108a-d are different sizes and/or types of pipes.

In some implementations, the camera 110 is positioned at an angle with respect to a vertical reference to capture a perspective view of the truck 102. For example, with an angled view, the camera 110 can capture images of pipes below the topmost layer of pipe. The pipes below the topmost layer of pipes can be oriented such that the unique identifiers attached to the pipes are visible by the camera with the angled view.

In some implementations, the camera 110 is positioned to capture an image of the back portion of the trailer 106 at a slight angle. For example, the camera 110 can be mounted to a structure that is positioned behind the truck 102 when the truck is stopped at the gate 122 (e.g., the structure can be positioned a few meters behind the back of the trailer 106 when the truck 102 is stopped at the gate 122). The camera 110 can capture the image of the pipes 108 and the unique identifiers 130a-d when the truck is stopped. Because the structure that the camera 110 is mounted on is behind the trailer 106, the camera 110 is mounted at a slight angle and/or an angle is generated based on the viewing angle or perspective of the camera 110 with respect to the truck 102 that enables the camera 110 to capture images of pipes 108 and unique identifiers 130a-d below the topmost layer of pipes 108 on the trailer 106.

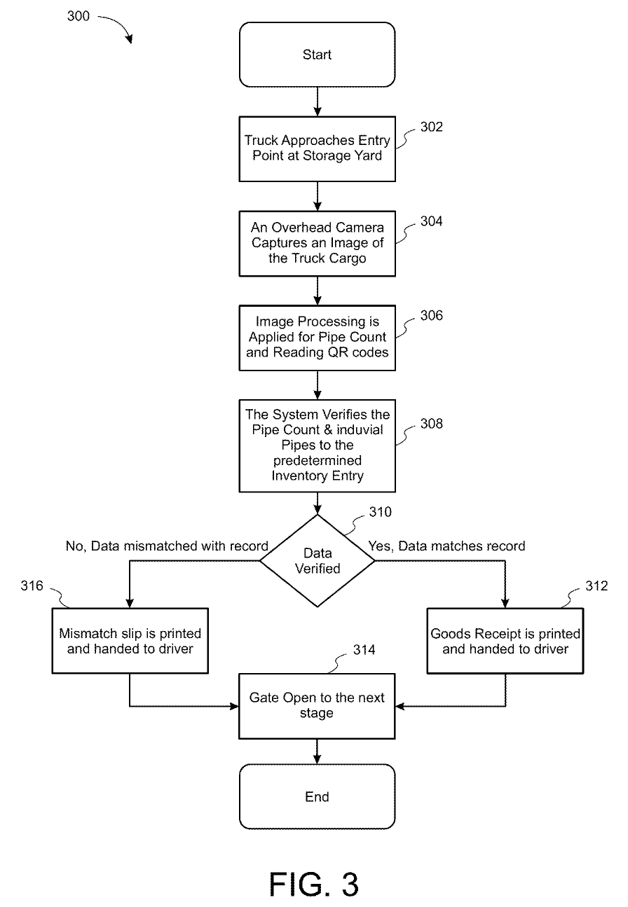

FIG. 3 is a flowchart for an example method 300 of identifying truck cargo during intake into a storage facility. The method 300 can be implemented on a data processing system (e.g., data processing system 112 or the computer of FIG. 5). The data processing system can execute the method 300 automatically and in real time in response to a trigger. For example, the data processing system can execute the method 300 upon arrival of a truck at an entry gate (step 302).

Real-time or near real-time processing and/or communication refers to a scenario in which received data (e.g., digital images) are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time communication system is configured to process digital image data as it arrives and determine a count and type of cargo as quickly as possible (though processing latency may occur). Though data can be buffered between module interfaces in a pipelined architecture, each individual module operates on the most recent data available to it. The overall result is a workflow that, in a real-time context, receives a data stream (e.g., digital image data) and outputs processed data (e.g., amount and type of cargo) based on that data stream in a first-in, first out manner. However, non-real-time contexts are also possible, in which data are stored (either in memory or persistently) for processing at a later time. In this context, modules of the data processing system do not necessarily operate on the most recent data available.

The data processing system captures an image of the truck cargo using an overhead camera (step 304). In some implementations, the overhead view is captured at an angle with respect to a vertical reference thereby enabling views of multiple layers of pipes.

The data processing system processes the image to determine a pipe count and to read QR codes on the pipes (step 306). For example, the data processing system uses a machine learning model that receives as input the captured image. The machine learning model is trained using training data that includes images of truck cargo labeled with pipe counts. The data processing system also isolates and decodes QR codes that include information about the type of pipes on the truck. The machine learning model can be used to identify the QR codes attached to each pipe. The data processing system can retrieve, e.g., from a database, information about the pipe based on the information in the QR code.

The data processing system compares the counted pipe quantity from the machine learning model and the specific pipes identified with QR codes with specified values indicated in an inventory system (step 308). The specified values include the expected number and type of pipes that are expected to be in the truck cargo (e.g., based on a shipping manifest).

If the data processing system determines that the determined data (pipe count and type) match the specified value (step 310), the data processing system can cause a goods receipt to be printed using a printer (step 312). The goods receipt can include, for example, the verified count and type of pipes, the truck information, time, date, and location. The goods receipt can be given to the driver of the truck for record keeping. After printing the goods receipt, the data processing system can cause the gate to open (step 314) to allow the truck to pass to the next stage of the intake process.

If the data processing system determines that the determined data does not match the specified value (step 310), the data processing system causes a mismatch slip to be printed using a printer (step 316). The mismatch slip includes, for example, the mismatched data, the truck information, the date and time, and the location. The mismatch slip can be handed to the driver to enable the driver to rectify the discrepancy. After printing the mismatch slip, the data processing system can cause the gate to be opened to allow the truck to proceed to the next stage in the intake process (step 314).

Although the method 300 has been described with respect to a truck entering a storage facility, the method 300 can be implemented in a similar manner for trucks leaving a storage facility with the method 300 being triggered based on the truck approaching an exit gate of the storage facility.

Alternatively, or additionally, to printing goods receipts and mismatch slips (steps 312, 316), the data processing system can render data for display on a display device (e.g., tablet screen, phone screen, monitor, display board). The data rendered for display can convey similar information as the goods receipt and mismatch slips.

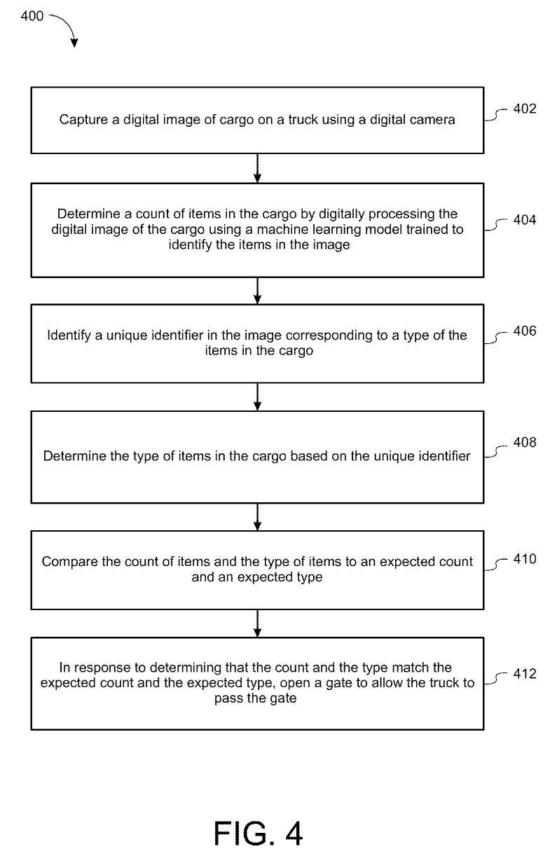

FIG. 4 is a flowchart for another method 400 for identifying cargo on a truck. The cargo can include, for example, pipes, fittings, or other items for use in oil and gas processing facilities. The method 400 can be implemented on a data processing system (e.g., data processing system 112 or the computer system of FIG. 5).

The data processing system captures a digital image of cargo on a truck using a digital camera (step 402). The digital camera can be positioned, for example, to view the truck cargo from above. Alternatively, or additionally, the digital camera can be positioned to view the truck and cargo from the side. The cargo can include, for example, pipes secured to a trailer attached to the truck. In some implementations, the data processing system captures the image when the truck is positioned in front of an entry or exit gate of a storage facility.

The data processing system determines a count of items in the cargo by digitally processing the digital image of the cargo using a machine learning model trained to identify the items in the image (step 404).

The data processing system identifies a unique identifier in the image corresponding to a type of the items in the cargo (step 406). For example, the data processing system identifies a QR code or a barcode in the image that has data encoded to uniquely identify the cargo item. The unique identifier can include encoded data such as a serial number, dimensions, material, etc. associated with the cargo item. The data processing system can extract the portion of the image that includes the identified unique identifier, and the data processing system can decode the information represented by the unique identifier. Alternatively, the data processing system can extract the information in the unique identifier using a machine learning model trained to extract the information from the unique identifier.

The data processing system can determine the type of the items in the cargo based on the unique identifier (step 408). For example, the data processing system decodes a QR code or bar code to determine the information associated with the cargo items.

The data processing system compares the count of items and the type of items to an expected count and an expected type (step 410). For example, the data processing system accesses the expected count and the expected type of the cargo from a database in an inventory management system. The data processing system can identify specific items that are intended to be in the shipment and compare the expected items to the items based on the unique identifier. In some implementations, the data processing system identifies the truck (e.g., based on a license plate number or fleet number) and accesses a shipping manifest in the inventory management system corresponding to the identified truck.

In response to determining that the count and the type match the expected count and the expected type, the data processing system opens a gate to allow the truck to pass the gate (step 412).

In some implementations, in response to determining that the count and the type do not match the expected count and the expected type, the data processing system prints a mismatch slip to be given to a driver of the truck. The mismatch slip indicates, for example, the count and the expected count that do not match. The data processing system can generate a flag in the inventory management system indicating that the truck was identified with a mismatch between the expected type and count of cargo and the determined type and count of cargo. The flag, for example, can indicate to personnel of the storage facility that the cargo needs additional inspection to confirm or correct the mismatch and/or partial match of cargo on the truck to preserve integrity of the inventory of the storage facility.

In some implementations, in response to determining that the count and the type match the expected count and the expected type, the data processing systems generate a command to print a goods receipt to be given to a driver of the truck. The goods receipt can indicate the count and the type of pipes that were verified by the data processing system.

In some implementations, in response to determining that the count and the type match the expected count and the expected type, the data processing system updates an inventory database based on the count of items and the type of items in the cargo.

In some implementations, the data processing system trains the machine learning model using images of cargo labeled with a number of items in the image. For example, the data processing system can form a training dataset based on images captured by the digital camera and labeled manually to determine the correct number of items in the image. The data processing system can train the machine learning model using the training dataset (or a subset of the training dataset) until the machine learning model achieves a threshold metric indicating the accuracy and generalizability of the trained machine learning model. Example metrics include root mean square error (RMSE), mean absolute error (MAE), mean squared error (MSE), and R-squared (R²) values. For example, the machine learning model can be trained to achieve an R² value of 95% to balance accuracy in prediction without overfitting the machine learning model to the training dataset.

In an example implementation, the data processing system generated a training dataset including 10,000 images of trucks transporting pipes. The images were labeled with the number pipes in the image and the location of the unique identifiers in the image. The data processing system trained a CNN to identify the number of pipes in the image and the location of the unique identifiers. The data processing system extracted the unique identifiers from the image based on the identified locations and decoded the information included in the unique identifiers.

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can hold data 516 (e.g., image data or inventory data). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms "client," "user," and other appropriate terminology can be used interchangeably, as appropriate, without departing from the scope of the present disclosure. Moreover, the present disclosure contemplates that many users can use one computer 502 and one user can use multiple computers 502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms "data processing apparatus," "computer," and "electronic computer device" (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### Examples

In an example implementation, a method for identifying cargo on a truck includes capturing a digital image of cargo on a truck using a digital camera; determining a count of items in the cargo by digitally processing the image of the cargo using a machine learning model trained to identify the items in the image; identifying a unique identifier in the image corresponding to a type of the items in the cargo; determining the type of the items in the cargo based on the unique identifier; and comparing the count of items and the type of items to an expected count and an expected type.

An aspect combinable with the example implementation includes in response to determining that the count and the type match the expected count and the expected type, opening a gate to allow the truck to pass the gate.

In another aspect combinable with one, some, or all of the previous aspects, the items include pipes secured to a trailer attached to the truck.

Another aspect combinable with one, some, or all of the previous aspects includes in response to determining that the count and the type do not match the expected count and the expected type, printing, using a printer, a mismatch slip to be given to a driver of the truck, the mismatch slip indicating the count and the expected count that do not match.

Another aspect combinable with one, some, or all of the previous aspects includes in response to determining that the count and the type match the expected count and the expected type, printing a goods receipt to be given to a driver of the truck.

Another aspect combinable with one, some, or all of the previous aspects includes in response to determining that the count and the type match the expected count and the expected type, updating an inventory database based on the count of items and the type of items in the cargo.

In another aspect combinable with one, some, or all of the previous aspects, the digital image is captured when the truck is positioned in front of a gate.

In another aspect combinable with one, some, or all of the previous aspects, the unique identifier includes a quick-response (QR) code that represents a serial number of an item or a type of the item.

In another aspect combinable with one, some, or all of the previous aspects, the QR code includes a high correction level to increase accuracy of determining the serial number of the item.

Another aspect combinable with one, some, or all of the previous aspects includes identifying the truck and accessing the expected count and the expected type for the cargo based on the identified truck.

Another aspect combinable with one, some, or all of the previous aspects includes training the machine learning model using images of cargo labeled with a number of items in the image.

In another example implementation, a system for identifying truck cargo includes a digital camera; at least one processor communicatively coupled to the digital camera; and a memory storing instructions that when executed by the at least one processor cause the at least one processor to perform operations including receiving, from the digital camera, an image of cargo on a truck; determining a count of items in the cargo by digitally processing the image of the cargo using a machine learning model trained to identify the items in the image; identifying a unique identifier in the image corresponding to a type of the items in the cargo; determining the type of the items in the cargo based on the unique identifier; comparing the count of items and the type of items to an expected count and an expected type; and in response to determining that the count and the type match the expected count and the expected type, performing an action.

In an aspect combinable with the example implementation, performing the action includes opening a gate.

In another aspect combinable with one, some, or all of the previous aspects, the operations include in response to determining that the count and the type do not match the expected count and the expected type, printing, using a printer, a mismatch slip to be given to a driver of the truck, the mismatch slip indicating the count and the expected count that do not match.

Another aspect combinable with one, some, or all of the previous aspects include a printer, and the operations include in response to determining that the count and the type match the expected count and the expected type, printing, using the printer, a goods receipt to be given to a driver of the truck.

In another aspect combinable with one, some, or all of the previous aspects, the operations include updating an inventory database based on the count of items and the type of items in the cargo.

In another aspect combinable with one, some, or all of the previous aspects, updating the inventory database occurs in response to determining that the count and the type match the expected count and the expected type.

In another aspect combinable with one, some, or all of the previous aspects, the digital camera is configured to capture an overhead image of the cargo on the truck when the truck is positioned in front of a gate.

In another aspect combinable with one, some, or all of the previous aspects, the unique identifier includes a quick-response (QR) code that represents a serial number of an item or a type of the item.

In another aspect combinable with one, some, or all of the previous aspects, the operations include identifying the truck, and accessing the expected count and the expected type for the cargo based on the identified truck.

What is claimed is:

1. A method for identifying cargo on a truck, the method comprising:
capturing a digital image of cargo on a truck using a digital camera;
determining a count of items in the cargo by digitally processing the image of the cargo using a machine learning model trained to identify the items in the image;
identifying a unique identifier in the image corresponding to a type of the items in the cargo;
determining the type of the items in the cargo based on the unique identifier; and
comparing the count of items and the type of items to an expected count and an expected type.

2. The method of claim 1 further comprising in response to determining that the count and the type match the expected count and the expected type, opening a gate to allow the truck to pass the gate.

3. The method of claim 1, wherein the items comprise pipes secured to a trailer attached to the truck.

4. The method of claim 1, further comprising in response to determining that the count and the type do not match the expected count and the expected type, printing, using a printer, a mismatch slip to be given to a driver of the truck, the mismatch slip indicating the count and the expected count that do not match.

5. The method of claim 1, further comprising in response to determining that the count and the type match the expected count and the expected type, printing a goods receipt to be given to a driver of the truck.

6. The method of claim 1, further comprising in response to determining that the count and the type match the expected count and the expected type, updating an inventory database based on the count of items and the type of items in the cargo.

7. The method of claim 1, wherein the digital image is captured when the truck is positioned in front of a gate.

8. The method of claim 1, wherein the unique identifier comprises a quick-response (QR) code that represents a serial number of an item or a type of the item.

9. The method of claim 8, wherein the QR code comprises a high correction level to increase accuracy of determining the serial number of the item.

10. The method of claim 1, further comprise identifying the truck, and accessing the expected count and the expected type for the cargo based on the identified truck.

11. The method of claim 1, further comprising training the machine learning model using images of cargo labeled with a number of items in the image.

12. A system for identifying truck cargo, the system comprising:
a digital camera;
at least one processor communicatively coupled to the digital camera; and
a memory storing instructions that when executed by the at least one processor cause the at least one processor to perform operations comprising:
receiving, from the digital camera, an image of cargo on a truck;
determining a count of items in the cargo by digitally processing the image of the cargo using a machine learning model trained to identify the items in the image;
identifying a unique identifier in the image corresponding to a type of the items in the cargo;
determining the type of the items in the cargo based on the unique identifier;
comparing the count of items and the type of items to an expected count and an expected type; and
in response to determining that the count and the type match the expected count and the expected type, performing an action.

13. The system of claim 12, wherein performing the action comprises opening a gate.

14. The system of claim 12, wherein the operations further comprise in response to determining that the count and the type do not match the expected count and the expected type, printing, using a printer, a mismatch slip to be given to a driver of the truck, the mismatch slip indicating the count and the expected count that do not match.

15. The system of claim 12, further comprising a printer, wherein the operations further comprise in response to determining that the count and the type match the expected count and the expected type, printing, using the printer, a goods receipt to be given to a driver of the truck.

16. The system of claim 12, wherein the operations further comprise updating an inventory database based on the count of items and the type of items in the cargo.

17. The system of claim 16, wherein updating the inventory database occurs in response to determining that the count and the type match the expected count and the expected type.

18. The system of claim 12, wherein the digital camera is configured to capture an overhead image of the cargo on the truck when the truck is positioned in front of a gate.

19. The system of claim 12, wherein the unique identifier comprises a quick-response (QR) code that represents a serial number of an item or a type of the item.

20. The system of claim 12, wherein the operations further comprise identifying the truck, and accessing the expected count and the expected type for the cargo based on the identified truck.
